(19) United States
(12) Patent Application Publication
(10) Pub. No.: US 2021/0222709 A1
(43) Pub. Date: Jul. 22, 2021

(54) Multi-Spring Position Control Apparatus and Methods

(71) Applicant: Flexibility Engineering, LLC, Loveland, CO (US)

(72) Inventors: Joseph W. Pawelski, Fort Collins, CO (US); Thomas Ingraham, Fort Collins, CO (US); Bradley N. Hammond, Denver, CO (US)

(21) Appl. No.: 16/747,386

(22) Filed: Jan. 20, 2020

(51) Int. Cl. F15B 11/15; F15B 11/20; F15B 18/00

(52) U.S. Cl. CPC F15B 11/15; F15B 18/00; F15B 11/20

(57) ABSTRACT

The inventive technology, in certain of its many embodiments, may present a y-number of physically biased, pressurized positioner assemblies, in a single positioner zone, where each assembly includes, inter alia, a plurality of n number of non-precision springs configured in a bimodal or trimodal configuration, and wherein an average of the absolute values of individual deviations, from a design effective spring rate, of the measured, effective spring rates of said positioner assemblies of said zone is less than an average of the absolute values of individual deviations, from said design effective spring rate, of y-number of non-precision springs manufactured to have said design effective spring rate. Spring configurations may be, e.g.: single/double/triple cylinder; single/double pressure cylinder; unimodal/bimodal/trimodal parallel, series and/or nested; internal/external; and/or symmetric/asymmetric. Certain embodiments may include an anti-buckling disc established between series configured springs. Additional aspects of the inventive technology may relate to, e.g., ability to use shorter springs to achieve an intended rate, inter alia.

### I. BACKGROUND OF THE INVENTION

The need to accurately position—and reposition as a new application may require—one or more items for proper operation of systems and apparatus has been known in several industries for years. Perhaps the most well-known such position control apparatus is a side guide position control apparatus, which find application in the bottling industry to maintain proper position of containers (bottles or cans, as but two examples) as they travel along a conveyor during processing (filling, capping, etc.). A similar type of position control apparatus may operate as part of a palletizing system to maintain the proper position of cases as they travel along a conveyor to the palletizer. Position control apparatus may also find application as part of a differential valve controller, as an HVAC mixing control system (as a substitute for expensive blowers) and as a programmable vehicle suspension system (where ground clearance is controlled), as but three of many examples. Indeed, the inventive position control apparatus disclosed and claimed herein may be used to control the position of components of a variety of different systems, where such components may benefit from repeated monitoring and adjustment to assure proper positioning (e.g., during a single “run” on a single bottle size) and/or, particularly in systems that are usable to process differently sized items (e.g., bottles of different sizes), where components may need to have their position adjusted before a specific “run” (e.g., on a different bottle size), depending on the size of an item processed during (and/or before) that “run,” and perhaps monitored and adjusted during that “run.”

Known systems involve the use of physically biased, pneumatically pressurized, piston-in-cylinder systems where a fluidic pressure (e.g., from pressurized air) is delivered to one side of a piston(s) in a cylinder(s), tending to move that piston(s) in a first direction, opposed by a bias force acting in a second, opposite direction. Control of the pressure against the bias force in such a physically biased, pressurized positioner assembly allows for steady positioning of a positioner (e.g., a positioner rod) that moves with the piston (whether with identical (inch for inch) correspondence or otherwise), whether that positioner extends from the piston(s) (and it attached/abuts thereto/therewith) and out of the cylinder(s) (and also perhaps spring end caps), or otherwise. Repositioning, even slightly so, may occur by adjusting/changing the pressure delivered to the cylinder, whether, e.g., on a single cylinder (e.g., on a single physically biased, pressurized positioner assembly) basis, or on a single zone, multiple positioner assembly basis. The bias force may allow for precise, stable positioning of the positioner as desired. That positioner can be attached (whether directly or indirectly, through additional components or force transfer members such as rods, bars, etc.) to whatever component it is desired to position, e.g., a side guide of a bottle conveyance system. It may be desired that all positioner assemblies of a single zone respond identically (or sufficiently so) to the same applied pressure, but this is not required in all embodiments.

There have been attempts in the past to provide position control systems that repeatedly monitor and adjust component(s), to the degree of accuracy desired, to assure proper positioning and/or facilitate adjustments necessitated, for example, by the different size of an item processed during a specific “run.” However, such systems often are excessively costly because the desired degree of accuracy may, under current available technologies, require the use of expensive precision springs, which have a reliably accurate spring rate. Certain embodiments of the inventive technology seek to avoid this expense, in addition to achieving other benefits, by offering a system that is amenable to the use of non-precision springs in configurations unique to the positioning industry. Benefits of the inventive technology may also or instead relate to the avoidance of buckling of serially configured springs, and/or the saving/conservation of space as compared with certain prior art systems.

### II. BRIEF SUMMARY OF THE INVENTION

Certain embodiments of the invention may find application in a position control system, e.g., a side guide position control system for a bottle conveyance system. More particularly, certain applications may involve bias elements (typically springs) of physically biased, pressurized positioner assemblies, where such bias elements are arranged in certain multi-spring configurations. Such configurations, e.g., combinations of series, parallel and/or nested modes, may allow for the use of less-expensive non-precision springs instead of precision spring(s) to achieve the desired positioning accuracy and/or may afford a conservation of valuable space (i.e., a “space savings”), whether with respect to spring free length, cylinder length, or other dimension.

### III. BRIEF DESCRIPTION OF SEVERAL VIEWS OF THE DRAWING

Note that it is not at all the case that every instance of a named and numbered component is called out (i.e., highlighted with a number and lead line/arrow) in the figures. Also, it is not the case that each figure shows each component comprehensively (e.g., certain parts of system 5 are not shown, for clarity).

FIG. 1 shows a view of an embodiment of a pressurized positioner assembly of the inventive technology.

FIG. 2 shows a view of an embodiment of a pressurized positioner assembly of the inventive technology.

FIG. 3 shows a view of an embodiment of a pressurized positioner assembly of the inventive technology.

FIG. 4A shows a side view of an embodiment of a pressurized, physically biased system of one positioning zone; FIG. 4B shows a perspective view from below of an embodiment of a pressurized, physically biased system of one positioning zone the inventive technology; and FIG. 4C shows a perspective view from above of an embodiment of a pressurized, physically biased system of one positioning zone.

FIG. 5A shows a close-up side view of an embodiment of a pressurized, physically biased system of one positioning zone; FIG. 5B shows a close-up perspective view from below of an embodiment of a pressurized, physically biased system of one positioning zone the inventive technology; and

FIG. 5C shows a close-up perspective view from above of an embodiment of a pressurized, physically biased system of one positioning zone.

FIG. 6A shows a close-up side view of an embodiment of a pressurized, physically biased system of one positioning zone; FIG. 6B shows a close-up perspective view from below of an embodiment of a pressurized, physically biased system of one positioning zone the inventive technology; and

FIG. 6C shows a close-up perspective view from above of an embodiment of a pressurized, physically biased system of one positioning zone.

FIG. 7 shows a view of an exemplary embodiment of a spring/cylinder configuration of a possible assembly of the inventive technology featuring helical coil springs in a single cylinder, unimodal nested internal spring configuration (note that unless indicated otherwise, the shown configuration is symmetric).

FIG. 8 shows a view of an exemplary embodiment of a spring/cylinder configuration of a possible assembly of the inventive technology featuring helical coil springs in a single cylinder, unimodal nested external spring configuration.

FIG. 9 shows a view of an exemplary embodiment of a spring/cylinder configuration of a possible assembly of the inventive technology featuring helical coil springs in a single cylinder, unimodal series internal spring configuration.

FIG. 10 shows a view of an exemplary embodiment of a spring/cylinder configuration of a possible assembly of the inventive technology featuring helical coil springs in a single cylinder, unimodal series external spring configuration.

FIG. 11 shows a view of an exemplary embodiment of a spring/cylinder configuration of a possible assembly of the inventive technology featuring helical coil springs in a single cylinder, bimodal series and nested internal spring configuration.

FIG. 12 shows a view of an exemplary embodiment of a spring/cylinder configuration of a possible assembly of the inventive technology featuring helical coil springs in a single cylinder, bimodal series and nested external spring configuration.

FIG. 13 shows a view of an exemplary embodiment of a spring/cylinder configuration of a possible assembly of the inventive technology featuring helical coil springs in a single cylinder, bimodal series and nested internal spring configuration (asymmetric).

FIG. 14 shows a view of an exemplary embodiment of a spring/cylinder configuration of a possible assembly of the inventive technology featuring helical coil springs in a triple cylinder, single pressure cylinder, bimodal parallel and nested internal spring.

FIG. 15 shows a view of an exemplary embodiment of a spring/cylinder configuration of a spring configuration of a possible assembly of the inventive assembly technology featuring helical coil springs in a triple cylinder, single pressure cylinder, bimodal parallel and series internal spring configuration.

FIG. 16 shows a view of an exemplary embodiment of a spring/cylinder configuration of a possible assembly of the inventive technology featuring helical coil springs in a double cylinder, double pressure cylinder, bimodal parallel and series internal spring configuration.

FIG. 17 shows a view of an exemplary embodiment of a spring/cylinder configuration of a possible assembly of the inventive technology featuring helical coil springs in a triple cylinder, single pressure cylinder, trimodal parallel, series and nested internal spring configuration.

FIG. 18 shows a view of an exemplary embodiment of a spring/cylinder configuration of a possible assembly of the inventive technology featuring helical coil springs in a double cylinder, double pressure cylinder, trimodal parallel, series and nested internal spring configuration.

FIG. 19 shows a view of an exemplary embodiment of a spring/cylinder configuration of a possible assembly of the inventive technology featuring helical coil springs in a single cylinder, single pressure cylinder, unimodal nested internal spring configuration.

FIG. 20 shows a view of an exemplary embodiment of a spring/cylinder configuration of a possible assembly of the inventive technology featuring helical coil springs in a triple cylinder, single pressure cylinder, bimodal parallel and nested internal spring configuration.

FIGS. 21A and 21B show an external spring (here, external of the pressure cylinder) configuration. FIG. 21A shows a side view while FIG. 21B shows a top view. This application may be for overhead guide rail adjustment. Each overhead adjustment assembly includes a common bar which 2 or more guide rail support brackets are attached to. This bar is suspended via bearings from an overhead support. There may be several biasers connected between the bar and the support, then the cylinder pushes against the bar which pushes against the biasers. Each overhead assembly is connected to the same control air, you may have dozens of these all connected to the same air line.

FIG. 22 shows a perspective view of the external biaser configuration of FIGS. 21A and 21B.

FIG. 23 shows regression curves and equations for Free Spring Length vs. Deflection Length by Bore Size for Nested (Only) Spring Configurations.

FIG. 24 shows regression curves and equations for Free Spring Length vs. Deflection Length by Bore Size for Various Bimodal, Series and Nested Configurations.

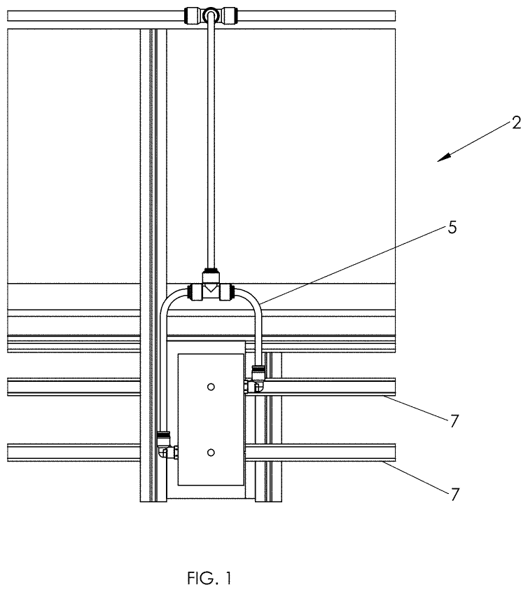

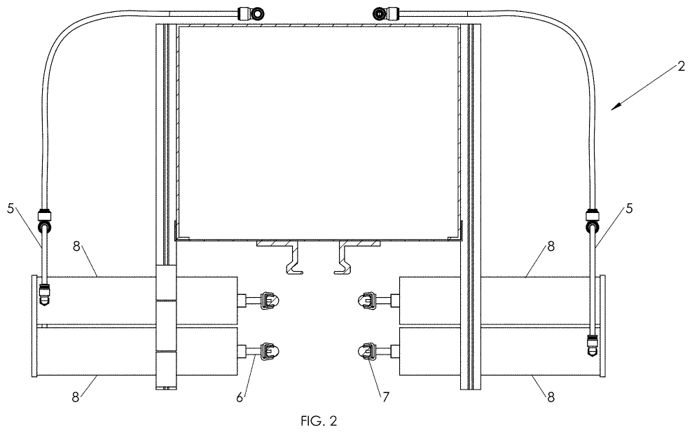

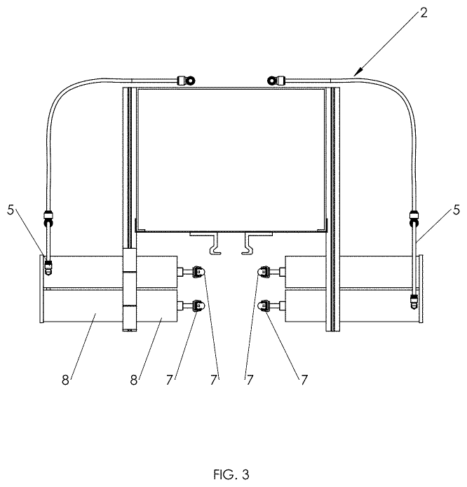

### IV. DETAILED DESCRIPTION OF THE INVENTION

It should be understood that the present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

Embodiments of the inventive technology may, at least in part, be described as a pressurized, physically biased system 1 (e.g., a position control system, such as for positioning side guides for a bottle conveyance system), at least part of which is pressurized via, e.g., a pressurized fluid such as air or other fluid, that comprises: a plurality of physically biased (e.g., via springs), pressurized positioner assemblies 2 of a single positioning zone 3, and a pressurized fluid source 4 and (fluidic) pressure transfer system 5 configured to supply pressurized fluid to said physically biased, pressurized positioner assemblies. The physically biased, pressurized positioner assemblies may control the position of a positioner 6 extending therefrom (at various times, depending on the position of the piston in the cylinder, the positioner may be within or outside of the cylinder, or be partially in and out); such positioner may be attached, directly or indirectly, with another component 7 (e.g., a side guide of a bottle conveyance system) of that assembly (note that the term positioner includes, e.g., any plates, bars, etc., that are outside of the cylinder and are attached to the component extending from the cylinder and that move with that component). The pressurized fluid source and pressure transfer system may be configured to supply pressurized fluid as indicated, via, e.g., a pressurized fluid source (e.g., pressurized air tank, such as an air compressor tank, or input line of pressurized air or other fluid) and pressure transfer system (e.g., pressurized fluid lines and associated fittings, e.g., the line fitting 18 where the pressurized fluid inputs to the pressure cylinder) that can transfer pressure from the source to the physically biased, pressurized positioner assemblies (and, more particularly, to a pressure cylinder(s) 8 thereof). Often, there may be one regulated pressure source per zone (but note, in certain applications, pressure to each physically biased, pressurized positioner assembly may also (or instead) be regulated), or instead there may be one source for a plurality of zones (with regulation of pressure per zone and possibly also per assembly). Note also that it is not the case that cylinders of the figures that are not indicated as being pressure cylinders are unpressurized; indeed, while cylinders shown with springs therein may or may not be pressurized (unless they are the only cylinder of the positioner assembly, in which case they typically are pressurized), cylinders without springs therein typically are pressurized.

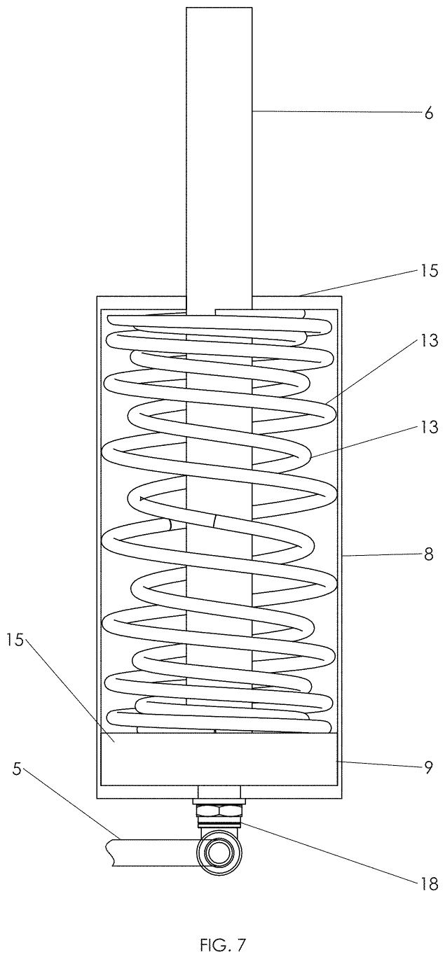

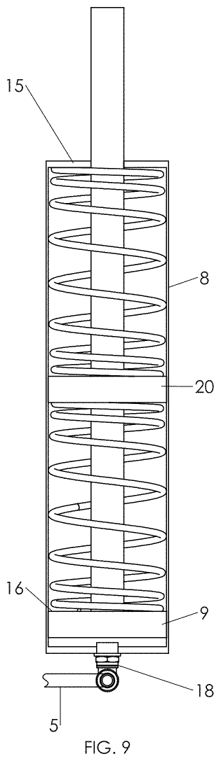

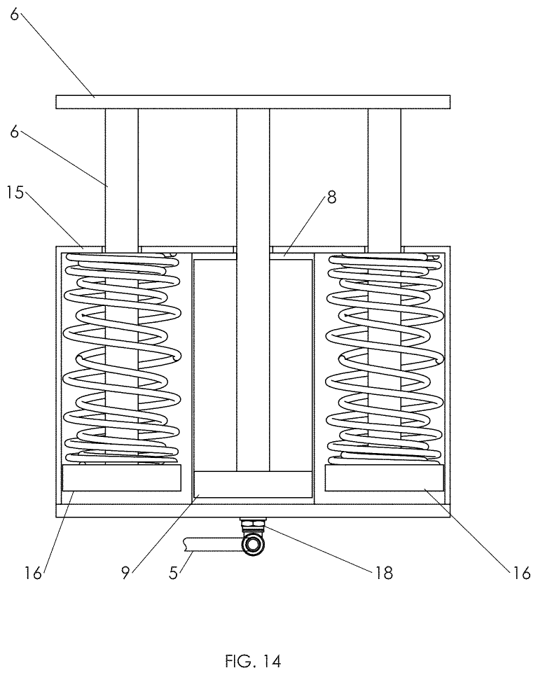

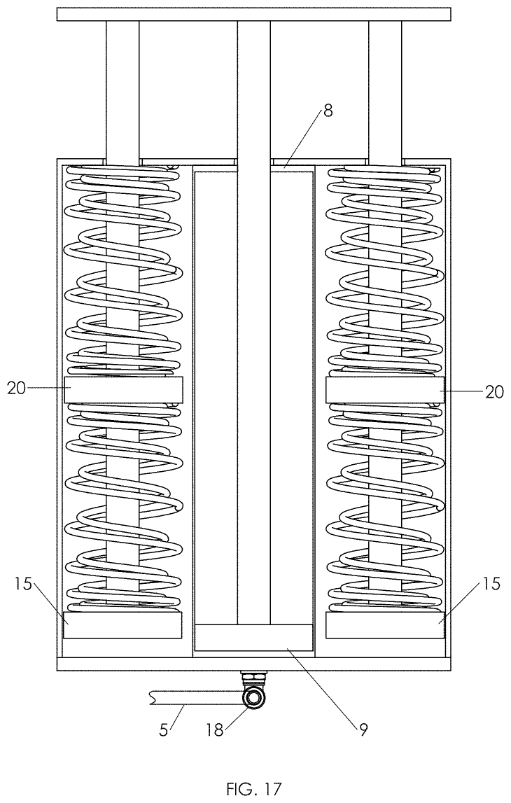

In particular embodiments, each of the physically biased, pressurized positioner assemblies may comprise at least one pressure cylinder 8 (possibly one among many) able to contain an internal, fluidic pressure; a piston 9 within the pressure cylinder; a pressure force 10 (e.g., pneumatic, or hydraulic, as but two examples) acting on the piston in a first relative direction 11 (e.g., northwest, towards a first end of the cylinder); and a plurality of springs 13 configured to exert an effective bias force 14 that is opposite said first relative direction 12 (e.g., southeast, towards a second end of the cylinder(s)). Bias elements (a general term that includes but is not limited to springs) configured to exert an effective bias force may, in particular embodiments, be so configured via physical interfacing (e.g., connections, perhaps even required when springs are under tension, and/or non-connective abutments, allowable when springs are under compression) of bias elements to/with componentry 15 (e.g., plate, positioner component, cylinder componentry, stationary componentry, cylinder end, cylinder piston, movable spring end cap, movable componentry, bias force transfer components rods and bars, positioner(s), side guides, etc.) that allow the bias elements to exert the effective bias force as intended. In many embodiments, one end of the spring moves with the piston, relative to another end of the spring (that is stationary relative to the piston, perhaps even attached to the piston), and bias force changes with piston displacement. Note that the movable spring end caps 16 (a broad term including but not limited to plates, discs, lattice, pucks, blocks, etc.) are not considered a type of piston where they do not contain (on one side) a pressurized fluid force, i.e., where they merely act to allow movement of one spring end relative to another as in FIGS. 14 and 17, and thus the changing of that bias force as applied against the pressure force. In particular spring configuration/positioner assembly embodiments, e.g., FIGS. 7 and 9, the piston may act as a movable spring end cap (seen in embodiments where a spring(s) is inside a pressure cylinder). Also of note is that certain known features of particular embodiments of the inventive technology may be as described in US2009/0288725 and/or US2012/0168284, each of which is incorporated herein in its entirety. Bias elements may act in compression or tension, e.g., depending on whether the spring(s) is on the same side of a piston as the pressurized fluid or not.

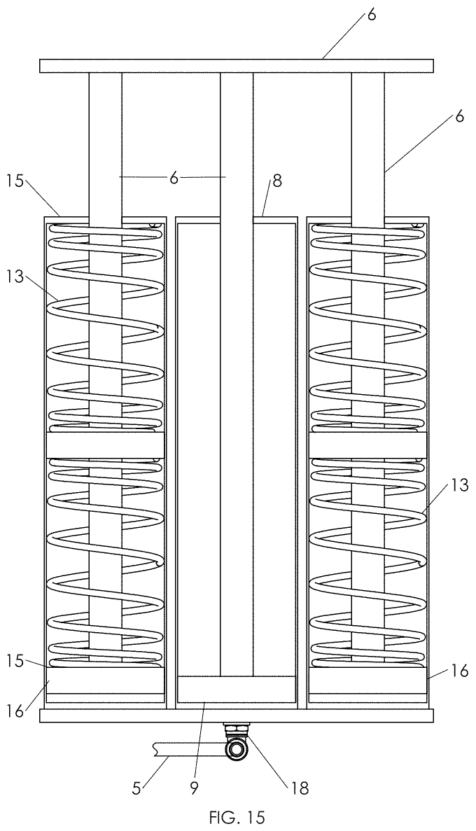

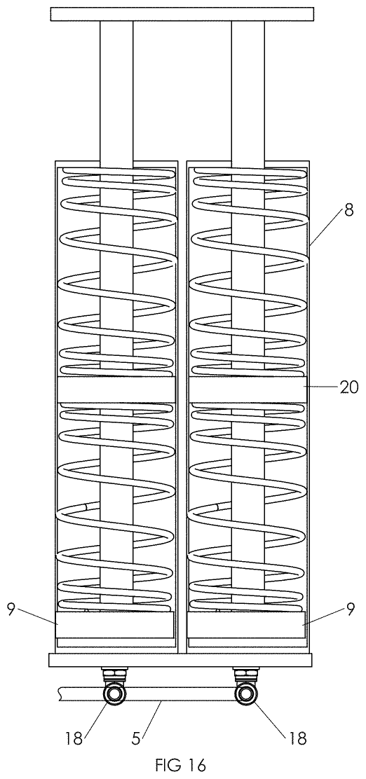

Note that bias elements include springs, whether linear or non-linear, helical spring, metal spring, plastic spring, fiberglass spring, coil spring, any known spring, in addition to contained air, pulleyed weight, etc. A preferred spring is the helical coil spring, although certainly other springs could be used. Generally, a spring is anything that effects a force that increases with displacement from neutral, uncompressed or unstretched position, whether linearly, non-linearly, or both (e.g., linearly except for non-linear force sometimes observed at the two extremes of possible displacement). Preferred embodiments involve linear springs (which may exhibit non-linear force-to-displacement response at the extreme ends of displacement, e.g., during maximal compression or extension). Note that FIGS. 7-18 show springs in an extreme (or near extreme) compression or tension mode, but of course, intermediate positions (e.g., where a piston is halfway between the ends of a pressure cylinder) are contemplated by the invention. Note also that spring rates expressed herein are typically the linear spring rate (e.g., the spring rate observed for compression and extension of the spring that is not at the extremes of compression or extension of that spring (where rates may potentially be non-linear)). Springs with non-linear response at only extremes of displacement (but with linear response elsewhere) are still considered linear springs. Any type of spring can have a spring rate; combinations of springs can have an effective spring rate.

The pressurized, physically biased system, in certain embodiments, may be a subsystem of sorts (e.g., one of several zones of a larger, multizone positioning system), where each positioning assembly in that positioning zone (again, perhaps one of many in the entire system) would ideally have exactly the same effective spring rate (so, a first positioner assembly of Zone 1 would have an effective spring rate of 90.0 lbs/in, and a second Positioner Assembly of that same Zone 1 would have an effective spring rate of 90.0 lbs/in, as would all positioner assemblies of that zone). Indeed, the closer the effective spring rate of each positioner assembly of a single zone (perhaps all pressurized in parallel from the same pressurized fluid source), the more likely it is that one pressure regulator can be used for the entire zone to achieve adequate position control, thereby avoiding the need for more expensive pressure regulation for each positioner assembly. Certain embodiments may include more than one, including all, of the assemblies (and other componentry) of the positioning zones of a single, multizone positioning system. Note that the system, regardless of whether it is one zone or more zones, typically would include a pressurized fluid source(s) (e.g., regulated air pressure source (e.g., regulated air compressor tank, or regulated line therefrom), perhaps one for each zone) and pressure transfer system configured to supply pressurized fluid to the physically biased, pressurized positioner assemblies (such is achieved where pressure is transferred to the pressure cylinder(s) of such physically biased, pressurized positioner assemblies via, e.g., air lines, tubing, etc.) Of course, a positioning system (whether for a single zone or for all zones of an entire system) may include other componentry, regulators, valves, etc., as is well known in the art.

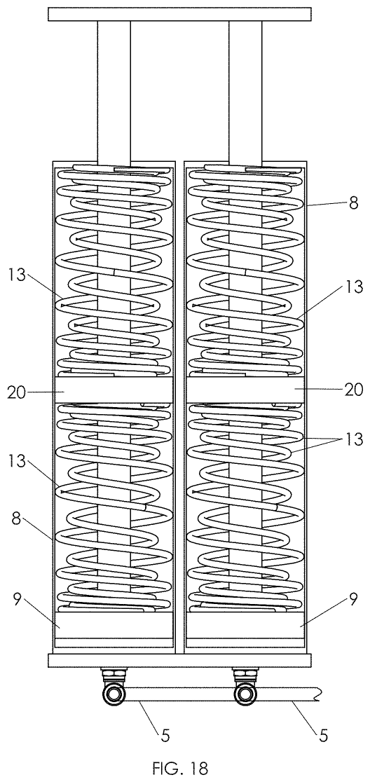

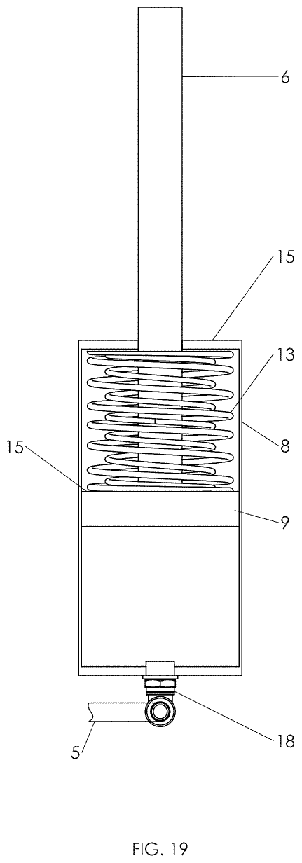

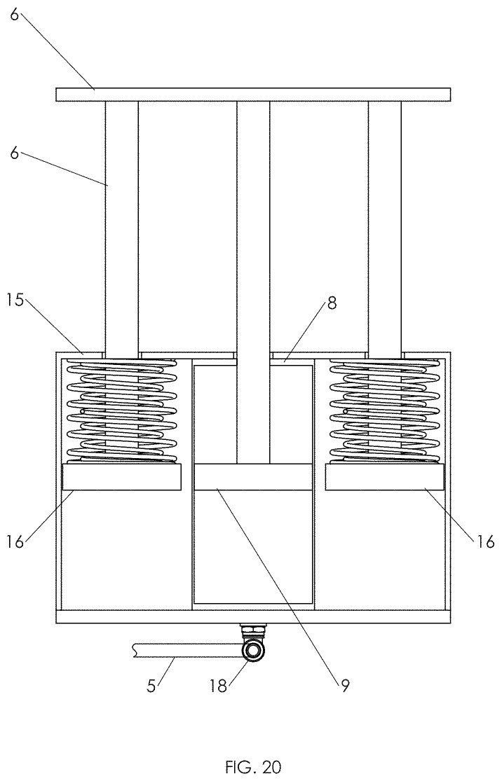

Physically biased, pressurized positioner assemblies may feature bias elements in either unimodal (e.g., strictly series or strictly parallel), bimodal (e.g., series and parallel, series and nested, nested and non-nested parallel), trimodal (e.g., parallel, series and parallel (e.g., nested)), etc. In a bimodal or trimodal configuration, a mode is either primary or secondary (or tertiary, in the case of a trimodal configuration). The assignment of modes is governed by the order (more precisely, the reverse order) in which the effective spring rate of the configuration is properly mathematically calculated. For example, in a trimodal parallel, series and nested configuration (see, e.g., FIGS. 17 and 18), the effective spring rate would be determined by first calculating each of the four nested spring assembly rates (tertiary mode), then calculating the two series rates (secondary mode; one for each of the two cylinders) using the first calculations, and then determining the overall rate by using the formula for springs in parallel (primary mode) using the second calculations. A multi-modal configuration (e.g., bimodal or trimodal) can have springs in any one or more of the following modes: series, parallel (nested and non-nested), non-nested parallel, and nested (where nested is considered a “type” of parallel configuration). Note also that certain sub-configurations can be repeated beyond what is shown in the figures. For example, FIG. 14 shows nested springs in parallel but, e.g., another set of parallel springs (whether nested or not) could be added to the configuration.

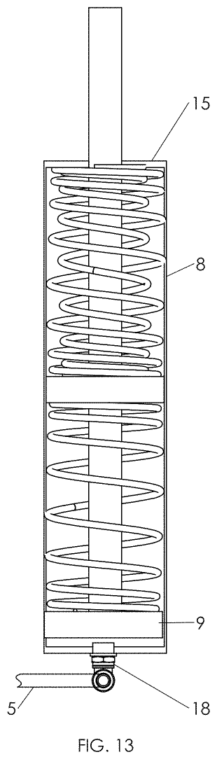

Also of note are the following with respect to assemblies: the inventive technology is not limited to those assembly configurations shown in the figures; each figure shows only an example of how such indicated configuration may appear; one or more of the cylinders of the shown multicylinder configurations may be pressurized; any of the non-pressurized, non-series cylinders that contain spring(s) could be made external; configurations need not necessarily be symmetric (see, e.g., FIG. 13), although typically springs in non-nested parallel configurations will have the same effective spring rate on each side of the axis of translational movement of the piston; spring axes may or may not be co-linear with a piston axis(es), although certain configurations, e.g., a single cylinder, bimodal series and nested internal spring configuration, will typically exhibit such feature; springs of an assembly may be internal of cylinder(s), external or both (indeed, in certain designs fewer than all springs of an assembly may be internal and remaining springs may be external); pressure cylinder(s) may or may not include springs; one or more of the cylinders might not contain springs in it; and one or more of the cylinders might be a pressure cylinder with a spring(s) in it. Note that any combination of two or more of series, parallel and nested sub-configurations may be found in embodiments of the inventive technology (e.g., series springs nested inside parallel springs, a type of trimodal configuration; non-nested springs in parallel that are then established in parallel; and nested springs in series, perhaps then also established in parallel configuration).

In particular embodiments, the bias elements (typically springs) of the physically biased, pressurized positioner assemblies of a single positioning zone (and sometimes of the entire multizone positioning system) are configured in one of the exemplary configurations shown in the figures. Note that the identifying terminology used with respect to the configurations shown in the figures follows the following conventions:
if there is only one total cylinder (see the first generic reference to cylinders in the identifying name of each configuration), e.g., single cylinder, then it is a pressure cylinder, so in such case there is no indication of the number of pressure cylinders (because there is one);
if there is more than one total number of cylinders, then there is an indication as to how many (one, all of the cylinders, or somewhere in between) are pressure cylinders;
a cylinder having at least a portion thereof pressurized (e.g., by pressurized air applied to its internal confines, e.g., via a pressurized air line that inputs to one end of the cylinder) is considered a pressure cylinder;
multimodal springs configurations are characterized using the following terminology: the correct type of multimode (either bimodal or trimodal), followed by the primary mode (e.g., parallel), followed by the secondary mode (e.g., series), followed by any tertiary mode (e.g., nested);
configurations are symmetric about all planes (e.g., vertical in the plane of the paper (of a figure), horizontal coming out of the paper, vertical coming out of the paper) where their spring configurations show such symmetry, unless indicated otherwise (note that springs that are in a nested configuration are typically of different spring rates (e.g., a first spring nested inside another has a lower spring rate than the spring in which it is nested); and
there may be an indication as to whether the springs are internal, external, or both.

Note also that the effective spring rate for springs in parallel is generated by adding the spring rates of the springs in parallel (if three identical springs are in parallel, the effective spring rate for those springs is 3×(spring rate)). For springs in series, the following gives the equivalent spring rate K_{eff}=(1/k₁+1/k₂+1/k₃+ . . . )⁻¹. [Note of course that the effective spring (i.e., effective bias) force is typically the effective spring rate (constant) for that assembly multiplied by the spring displacement from free length.] So, if three identical springs are in series, then the effective spring rate would be k_{identical}/3. Of course, these equations can be used to design a physically biased, pressurized positioner assembly that exhibits an effective spring rate, where individual springs, perhaps even with different spring rates in certain applications, are selected with the goal of getting as close to the design effective spring rate (i.e., the intended effective spring rate that the application requires or that is preferred for the design) as possible. Note that, while indeed that may be a goal, it may be an even more important goal that all of the physically biased, pressurized positioner assemblies of a single zone exhibit the same spring rate (or as close as possible to the same spring rate), whatever that spring rate may be. This is because the regulated fluid (e.g., air) pressure source (e.g., an air compressor tank, or line therefrom) can be adjusted so that its output is at a pressure that yields the proper extension of the positioner of the physically biased, pressurized positioner assemblies in fluidic communication with that source, resulting in a substantially equal (i.e., within 10%, as where the different between the two referenced values are less than or equal to 10% of the larger of the referenced values) extension of each positioner of the assemblies of that zone (which may be a goal of certain embodiments of the inventive technology). Note that nested springs are treated as parallel springs, and that in certain applications, a first spring that is nested within another (second) spring may have a different spring rate from that second spring. This is not, however, a requirement. What may be critical, however, is that in embodiments with non-nested parallel springs (e.g., two or more springs spaced equally (e.g., 180 degrees for two springs; 120 degrees for 3 springs; 90 degrees for 4 springs, etc.) have the same (effective spring rate) so as to maintain a balanced response (the term spring, of course, potentially including one or more than one individual springs). Springs in series (and, as mentioned, nested springs) may have different rates, effective or otherwise.

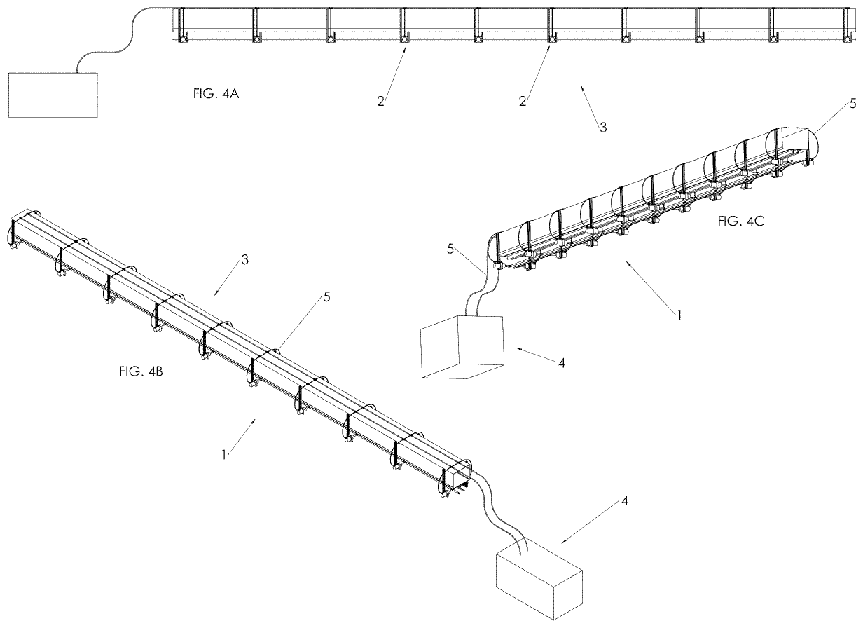

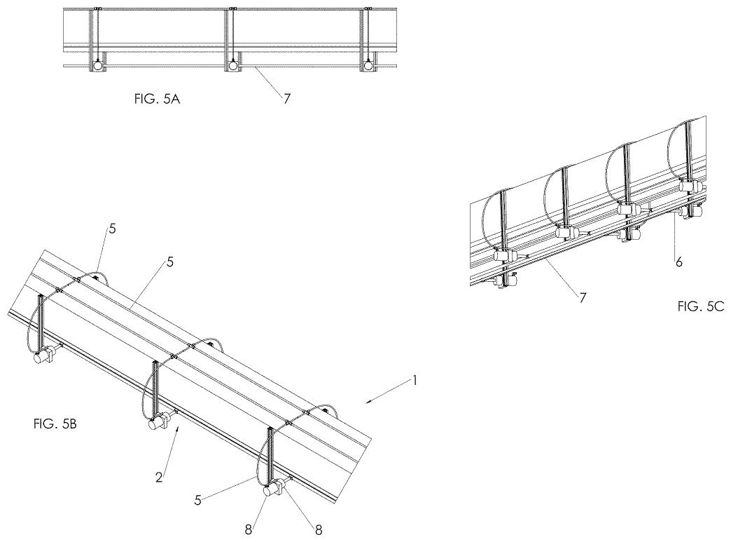

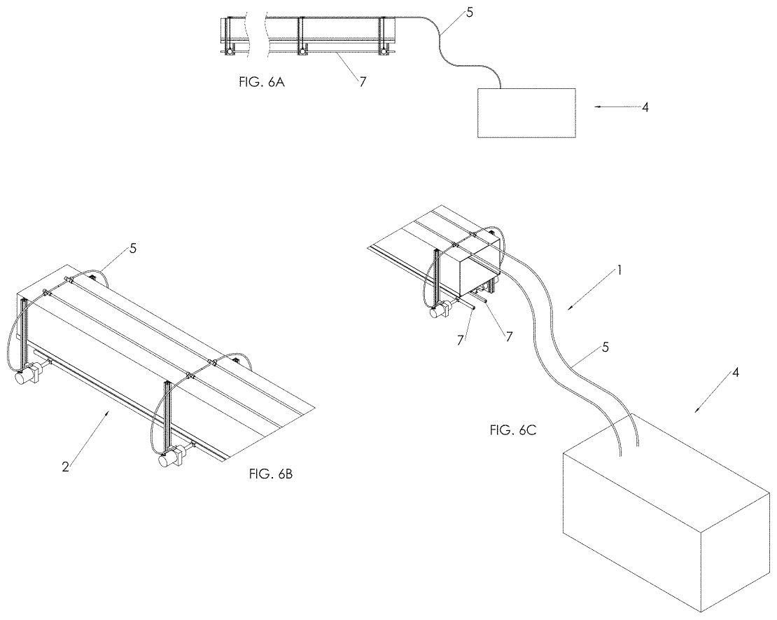

In certain embodiments, the springs of a single physically biased, pressurized positioner assembly may be of “n” number (e.g., 2-8, as but one possible range). They may be, e.g., non-precision springs (i.e., springs that are not manufactured/marketed as “precision springs”), in certain embodiments. A single positioning zone may include y-number of physically biased, pressurized positioner assemblies (e.g., 24 in FIG. 4); each zone of an entire position control system may or may not include the same number of physically biased, pressurized positioner assemblies. The effective bias force of each of the positioner assemblies of a zone may exhibit a measured respective effective spring rate (respective in that it may be different, perhaps even only slightly, for each physically biased, pressurized positioner assembly) that deviates from a design effective spring rate by a respective first value, the absolute value of each of which (or at least 90% of which) may be less than the average of the absolute values of individual deviations, from that design effective spring rate, of the measured, actual spring rates of y-number of (randomly selected) non-precision springs manufactured to have that design effective spring rate. This may be the case for one, two, three, all but one, or all zones of a system.

TABLE 1
Example 1 (Y = 5, Design Effective Spring Rate of 3.0 inch/lb)

| Measured Actual Spring Rate | Respective Deviation from | Absolute Values of |
|---|---|---|
| of Y Number of Non- | Design Effective Spring Rate | Respective Deviations (of the |
| Precision Springs (inch/lb) | (inch/lb) | Non-Precision Springs) |
| 3.10 | +0.10 | 0.10 |
| 2.93 | −0.13 | 0.13 |
| 2.80 | −0.20 | 0.20 |
| 3.12 | +0.12 | 0.12 |
| 3.06 | 0.06 | 0.06 |

Average of |Deviations|=Σ_{absolute values of deviations}/5=0.122
Absolute Values of Deviations of Measured Respective Effective Spring Rates (of Positioner Assemblies of a Single Zone) From Design Effective Spring Rate: 0.1, 0.12, 0.11, 0.06, 0.04, each of which is less than 0.122)

In other embodiments, the average of the absolute values of individual deviations, from the design effective spring rate, of the measured respective effective spring rates of the positioning assemblies of a zone may be less than the average of the absolute values of individual deviations, from that design effective spring rate, of the measured, actual spring rates of y-number of (randomly selected) non-precision springs manufactured to have that design effective spring rate. This may be the case for one, two, three, all but one, or all zones of a system.

TABLE 2
Example 2 (Y = 5, Design Effective
Spring Rate of 3.0 inch/lb) (using data above)

| Measured Actual (Effective) | | |
|---|---|---|
| Spring Rate of Y Number of | Respective Deviation from | |
| Positioning Assemblies | Design Effective Spring Rate | Absolute Values of |
| (inch/lb) | (inch/lb) | Respective Deviations |
| 3.05 | +0.05 | 0.05 |
| 3.01 | +0.01 | 0.01 |
| 2.85 | −0.15 | 0.15 |
| 3.04 | +0.04 | 0.04 |
| 2.97 | −0.03 | 0.03 |

Average of |Deviations|=Σ_{absolute values of deviations}/5=0.056, which is less than 0.122.
   As such, by using non-precision springs in any of the unique multi-spring configurations disclosed herein, effective spring rates may be closer to the design effective spring rate. Such may improve and facilitate system operation, and possibly even lower operational and/or equipment costs. Note that additional zones (i.e., not just one) of a multi-zone system may exhibit either, or both of the above.

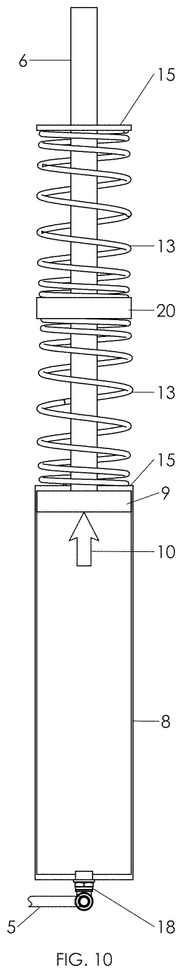

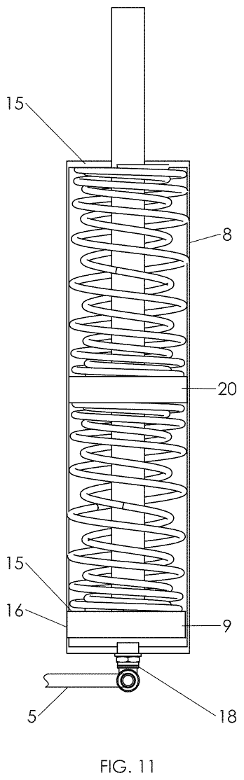

In certain embodiments, at least some of said plurality of springs are in series configuration, and, in some of such embodiments, the apparatus may further include at least one anti-buckling disc 20, each of which may be established between two different series configured springs (which is seen even where there is a nested pair of springs on one side of the disc and a different nested pair on the other, i.e., where two nested pairs of springs are in series). The anti-buckling disc, e.g., between ends of series configured springs, often with a hole through its center (in which case it is a collar, which is still considered a type of disc) through which, e.g., a positioner rod or bias force transfer rod may pass, perhaps slidingly (such that relative motion between the disc and the force transfer rod is allowed), may provide guidance for the serial springs and prevent buckling, in addition to improving the consistency of the linearity of the force effected by such springs. This may, in certain embodiments, at least in part, be achieved via high tolerance manufacturing that prevents the disc from rubbing against the cylinder's internal wall (or that allows only light contact with such wall), keeping the springs concentric (some sliding contact with the rod that passes through the center of the collar may be acceptable). When springs are mounted sideways (e.g., horizontally), the disc may act to reduce the chance that springs buckle, although rubbing of the disc against the cylinder internal wall in such sideways application may be hard to avoid. The anti-buckling disc allows for the use of two springs in series (with the disc between them) that will not buckle as a replacement for one long spring that will buckle. Note that anti-buckling disc(s) may be used between springs in series that are both internal of (e.g., FIG. 11), and external of (e.g., FIG. 10), a cylinder. The anti-buckling disc may be made of low coefficient of friction material, including but not limited to Teflon and UHMW plastic; it may be as this as possible in order to not appreciably add length to the serial springs (or limit the serial springs total length in the case where they need to fit inside a cylinder of a certain length). Further, the ends of the serial springs proximate the disc could be pressed into the disc.

Note that embodiments of the inventive technology—particularly those involving springs that are in nested or non-nested parallel configuration—may effect space savings (e.g., a reduced cylinder volume, free spring length, or extended length occupied by a physically biased, pressurized positioner assembly) as compared with a design using a single spring (or springs in series) to generate the (same) required design effective spring rate (such “compared” design would typically feature that single spring configured to have a longitudinal spring axis that is co-linear with the axis of the positioner rod), or more generally a design that does not use parallel (including nested) springs. Parallel spring configurations (i.e., any configuration featuring one or more parallel (including nested) spring assembly) of physically biased, pressurized positioner assemblies may in particular offer significant space-saving benefits. Indeed, additional advantages of the inventive technology may relate to improved utilization of space, and in particular the use of less space to achieve a desired bias and/or positioning effect (e.g., a desired effective spring rate) as compared with conventional technologies. Such space conservation may provide cost, design and operational benefits, among other benefits, as compared with conventional systems. Further, a reduction in the required spring length may mitigate spring buckling problems encountered during positioning system operation.

Note that in any of the multi-spring configurations, it may be said that the plurality of springs are all substantially of the same outer diameter D or are of at least two different outer diameters with at least one spring having a largest outer diameter that is D (the latter typically observed with respect to nested springs, where a spring nested inside another typically has a smaller outer diameter than that of the spring in which it is nested, as in, e.g., Table 3). Also, as to any of the multi-spring configurations, in particular embodiments, it may be said that the plurality of springs are all substantially of the same length L (often seen with parallel, including nested, spring configurations). As used herein, substantially means within 10%, as indicated elsewhere herein. It is further of note that any one or more of the springs that are in parallel configuration (whether nested or not) may actually comprise two or more springs (i.e., a subset of springs) that themselves may actually be in series and/or parallel (including nested). configuration. As such, and as mentioned, a spring may include more than one spring unit.

Table 3 shows data for unimodal, nested spring configuration (for a single physically biased, pressurized positioner assembly) where such springs are not placed in series (i.e., nested only), for various effective spring rates, numbers of springs, bore sizes, and deflection lengths. Single (for the nested configuration), refers to a design with one spring, Spring A (no nesting); Dual refers to a design where Spring B is nested inside Spring B; and Triple refers to a design where Spring C is nested inside Spring B which is nested inside Spring A. Table 3 data shows that for nested spring configuration embodiments of the inventive technology, the more springs that are nested, the greater the reduction in free length required to meet specific design constraints. Note that, as with all table data, data is for a single physically biased, pressurized positioner assembly, and springs have closed ground ends, are of music wire, helical non-precision springs, and show data in inches where not indicated elsewhere.

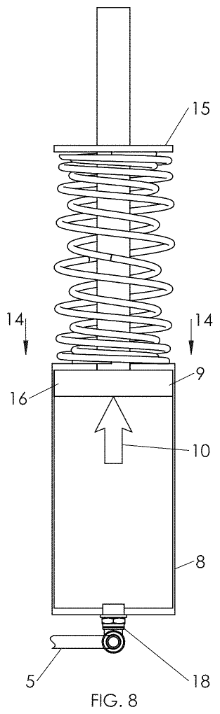

Table 3 illustrates how, in order to get a desired working deflection (e.g., 6″, 4″ or 2″) under particular design constraints [e.g., a specific (cylinder) bore diameter (or largest OD of spring(s)), combined (i.e., effective) spring rate, and similar type springs (e.g., all music wire springs with closed ground ends), but perhaps with different spring rates], nested parallel springs (see, e.g., FIGS. 7 and 8) in a cylinder of a certain bore size (diameter) may allow for the use of springs with a smaller free length as compared to the required free length of a single spring necessary to provide that deflection under those design constraints. For example, as the tables show, the use of one spring nested in another spring (i.e., dual nested, “in-cylinder” springs) requires springs with a smaller free length than required with a single spring (again, under the same deflection, effective spring rate and bore size constraints). More particularly, for 6″ working deflection (and 2.5″ cylinder bore diameter and effective (combined) spring rate of 90 lb/in), a single spring requires a spring with a free length of 13″, while a dual nested configuration (one spring nested in another) requires springs of only 10.75″ free length). And a triple nested configuration—where one spring (spring C) is nested inside another spring (spring B) which is nested inside a third spring (spring A)—allows for use of an even smaller free length (of all three springs) of 9.5″. A related parameter—Free Length/Working Deflection—reflects the same trend: in the case of nested springs, smaller space utilization for a required working deflection for a given design (as compared with single spring configurations under the same design constraints). Note, incidentally, that in the Dual and Triple Nested designs, spring B is nested in spring A (and spring C in spring B in the Triple Nested design). Embodiments of the inventive technology may allow for use of springs that are at least 2% shorter, at least 5% shorter, at least 10% shorter, at least 15% shorter, at least 20% shorter, at least 25% shorter, at least 30% shorter, or at least 40% shorter than the length of a single spring required under the same design constraints (e.g., same working deflection, same effective spring rate, same cylinder bore diameter, same “type” spring (note that the related parameter of free length/working deflection may illustrate similar reduction). The exact extent of the length reduction may perhaps depend on the number of springs used in the nested configuration (one nested inside another is considered a dual nested configuration; one nested inside another that is nested inside a third spring is considered a triple nested configuration).

TABLE 3
Unimodal, Nested Spring Configuration
Bore Diameter: 2.5 inches
4.909 area (sq. ins.)
Combined Rate: 90 lb/inch

| | | Dual | | Triple | | |
|---|---|---|---|---|---|---|
| | Single | A | B | A | B | C |
| Working Deflection (Lw) | 6 | 6 | 6 | 6 | 6 | 6 |
| Free Length (L) | 13 | 10.75 | 10.75 | 9.5 | 9.5 | 9.5 |
| Rate (lb/in) | 90 | 60 | 30 | 40 | 30 | 20 |
| Wire (d inches) | 0.324 | 0.28 | 0.2 | 0.243 | 0.2 | 0.16 |
| Mean Dia (inches) | 2.08 | 2.145 | 1.55 | 2.165 | 1.705 | 1.3405 |
| Deflection (inches) | 6 | 6.02 | 6.23 | 6.03 | 6 | 6.04 |
| Deflection vs Free Length | 2.2 | 1.8 | 1.8 | 1.6 | 1.6 | 1.6 |
| Free Length Reduction vs Single Spring | | 17% | | 27% | | |
| Working Deflection (Lw) | 4 | 4 | 4 | 4 | 4 | 4 |
| Free Length (L) | 9 | 7 | 7 | 6 | 6 | 6 |
| Rate (lb/in) | 90 | 60 | 30 | 40 | 35 | 15 |
| Wire (d inches) | 0.3 | 0.25 | 0.19 | 0.21 | 0.183 | 0.13 |
| Mean Dia (inches) | 2.1 | 2.15 | 1.7 | 2.15 | 1.73 | 1.35 |
| Deflection (inches) | 4.2 | 4.15 | 4.21 | 4.11 | 4.01 | 4.3 |
| Deflection vs Free Length | 2.3 | 1.8 | 1.8 | 1.5 | 1.5 | 1.5 |
| Free Length Reduction vs Single Spring | | 22% | | 33% | | |
| Working Deflection (Lw) | 2 | 2 | 2 | 2 | 2 | 2 |
| Free Length (L) | 3.5 | 3 | 3 | 2.75 | 2.75 | 2.75 |
| Rate (lb/in) | 90 | 60 | 30 | 40 | 30 | 20 |
| Wire (d inches) | 0.23 | 0.195 | 0.15 | 0.167 | 0.141 | 0.115 |
| Mean Dia (inches) | 2.25 | 2.25 | 1.85 | 2.325 | 1.9 | 1.55 |
| Deflection (inches) | 2.14 | 2.02 | 2.13 | 2.05 | 2.07 | 2.13 |
| Deflection vs Free Length | 1.8 | 1.5 | 1.5 | 1.4 | 1.4 | 1.4 |

| | | |
|---|---|---|
| Free Length Reduction vs Single Spring | 14% | 21% |

Bore Diameter: 2″
3.142 area
Combined Rate: 57.6 lb/inch

| | | Dual | | Triple | | |
|---|---|---|---|---|---|---|
| | Single | A | B | A | B | C |
| Working Deflection (Lw) | 6 | 6 | 6 | 6 | 6 | 6 |
| Free Length (L) | 12.5 | 10.5 | 10.5 | 9.25 | 9.25 | 9.25 |
| Rate (lb/in) | 57.6 | 40 | 17.6 | 25.6 | 20 | 12 |
| Wire (d inches) | 0.255 | 0.225 | 0.16 | 0.1927 | 0.161 | 0.1245 |
| Mean Dia (inches) | 1.65 | 1.725 | 1.3 | 1.76 | 1.385 | 1.07 |
| Deflection (inches) | 6 | 6.02 | 6.28 | 6.13 | 6 | 6.08 |
| Deflection vs Free Length | 2.1 | 1.8 | 1.8 | 1.5 | 1.5 | 1.5 |
| Free Length Reduction vs Single Spring | | 16% | | 26% | | |
| Working Deflection (Lw) | 4 | 4 | 4 | 4 | 4 | 4 |
| Free Length (L) | 7.125 | 6.4 | 6.4 | 5.6 | 5.6 | 5.6 |
| Rate (lb/in) | 57.6 | 40 | 17.6 | 25.6 | 20 | 12 |
| Wire (d inches) | 0.224 | 0.197 | 0.14 | 0.165 | 0.1365 | 0.108 |
| Mean Dia (inches) | 1.75 | 1.75 | 1.35 | 1.76 | 1.37 | 1.1 |
| Deflection (inches) | 4.055 | 4.02 | 4.33 | 4.02 | 4 | 4.07 |
| Deflection vs Free Length | 1.8 | 1.6 | 1.6 | 1.4 | 1.4 | 1.4 |
| Free Length Reduction vs Single Spring | | 10% | | 21% | | |
| Working Deflection (Lw) | 2 | 2 | 2 | 2 | 2 | 2 |
| Free Length (L) | 3.25 | 2.85 | 2.85 | 2.625 | 2.625 | 2.625 |
| Rate (lb/in) | 57.6 | 40 | 17.6 | 25.6 | 20 | 12 |
| Wire (d inches) | 0.175 | 0.151 | 0.11 | 0.128 | 0.112 | 0.09 |
| Mean Dia (inches) | 1.7 | 1.75 | 1.4 | 1.76 | 1.5 | 1.25 |
| Deflection (inches) | 2.06 | 2.02 | 2.15 | 2.015 | 2.025 | 2.085 |
| Deflection vs Free Length | 1.6 | 1.4 | 1.4 | 1.3 | 1.3 | 1.3 |

| | | |
|---|---|---|
| Free Length Reduction vs Single Spring | 12% | 19% |

Bore Diameter: 1.5″
1.767 area
Combined Rate: 32.4 lb/in

| | | Dual | | Triple | | |
|---|---|---|---|---|---|---|
| | Single | A | B | A | B | C |
| Working Deflection (Lw) | 6 | 6 | 6 | 6 | 6 | 6 |
| Free Length (L) | 11.75 | 10 | 10 | 8.85 | 8.85 | 8.85 |
| Rate (lb/in) | 32.4 | 21.6 | 10.8 | 14.4 | 10.8 | 7.2 |
| Wire (d inches) | 0.19 | 0.164 | 0.119 | 0.1415 | 0.1178 | 0.0926 |
| Mean Dia (inches) | 1.27 | 1.29 | 0.95 | 1.32 | 1.05 | 0.8 |
| Deflection (inches) | 6.01 | 6 | 6.06 | 6 | 6.01 | 6.01 |
| FreeLength/Working Deflection | 2.0 | 1.7 | 1.7 | 1.5 | 1.5 | 1.5 |
| Free Length Reduction vs Single Spring | | 15% | | 25% | | |
| Working Deflection (Lw) | 4 | 4 | 4 | 4 | 4 | 4 |
| Free Length (L) | 6.75 | 6 | 6 | 5.5 | 5.5 | 5.5 |
| Rate (lb/in) | 32.4 | 21.6 | 10.8 | 14.4 | 10.8 | 7.2 |
| Wire (d inches) | 0.162 | 0.1405 | 0.101 | 0.1222 | 0.105 | 0.0805 |
| Mean Dia (inches) | 1.27 | 1.29 | 0.95 | 1.32 | 1.05 | 0.8 |
| Deflection (inches) | 4.01 | 4.02 | 4.16 | 4.07 | 4.03 | 4.02 |
| FreeLength/Working Deflection | 1.7 | 1.5 | 1.5 | 1.4 | 1.4 | 1.4 |
| Free Length Reduction vs Single Spring | | 11% | | 19% | | |
| Working Deflection (Lw) | 2 | 2 | 2 | 2 | 2 | 2 |
| Free Length (L) | 3 | 2.75 | 2.75 | 2.5 | 2.5 | 2.5 |
| Rate (lb/in) | 32.4 | 21.6 | 10.8 | 14.4 | 10.8 | 7.2 |
| Wire (d inches) | 0.1276 | 0.1105 | 0.08 | 0.0942 | 0.0815 | 0.0625 |
| Mean Dia (inches) | 1.3 | 1.32 | 1 | 1.33 | 1.15 | 0.8 |
| Deflection (inches) | 2.06 | 2.05 | 2.15 | 2 | 2.02 | 2 |
| FreeLength/Working Deflection | 1.5 | 1.4 | 1.4 | 1.3 | 1.3 | 1.3 |
| Free Length Reduction vs Single (Series) | | | | | | |

| | | |
|---|---|---|
| Spring | 8% | 17% |

In one example shown in Table 3:
Spring A has a 90 lb/in rate and fits with a 2.5″ diameter. The free length of the spring is 13″ and the max deflection under load is 6″. Therefor the Free Length/Displacement length (F/D) ratio is 13/6 or “2.2”
Spring B also has a 90 lb/in rate and fits with a 2.5″ diameter. The free length of the spring is 10.75″ and the max deflection under load is 6″. Therefor the Free Length/Displacement length (F/D) ratio is 10.75/6 or “1.8”.
   Generally speaking as long as the springs both meet design criterial for rate and life cycle, the lower (F/D) ratio is preferred both for space savings and to reduce the opportunity for buckling. Also, buckling affects how linear the spring rate is over the displacement. When a spring is significantly longer than its diameter combined with a high F/D ratio it is likely to buckle.

Table 4 shows a summary of Table 3 data, presented in alternate format.

TABLE 4
Summary of Free Spring Length Data for Nested (Only) Springs

| | Free Spring Length (ins.) | | |
|---|---|---|---|
| Deflection Length | 2 | 4 | 6 |
| 2.5 Bore, 90 lb Rate | | | |
| 1 Spring 2.5 Bore | 3.5 | 9 | 13 |
| 2 Springs 2.5 Bore | 3 | 7 | 10.75 |
| 3 Springs 2.5 Bore | 2.75 | 6 | 9.5 |
| 2.0 Bore, 57.6 Rate | | | |
| 1 Spring 2.0 Bore | 3.25 | 7.125 | 12.5 |
| 2 Springs 2.0 Bore | 2.85 | 6.4 | 10.5 |
| 3 Springs 2.0 Bore | 2.625 | 5.6 | 9.25 |
| 1.5 Bore, 32.4 Rate | | | |
| 1 Spring 1.5 Bore | 3 | 6.75 | 11.75 |
| 2 Springs 1.5 Bore | 2.75 | 6 | 10 |
| 3 Springs 1.5 Bore | 2.5 | 5.5 | 8.85 |

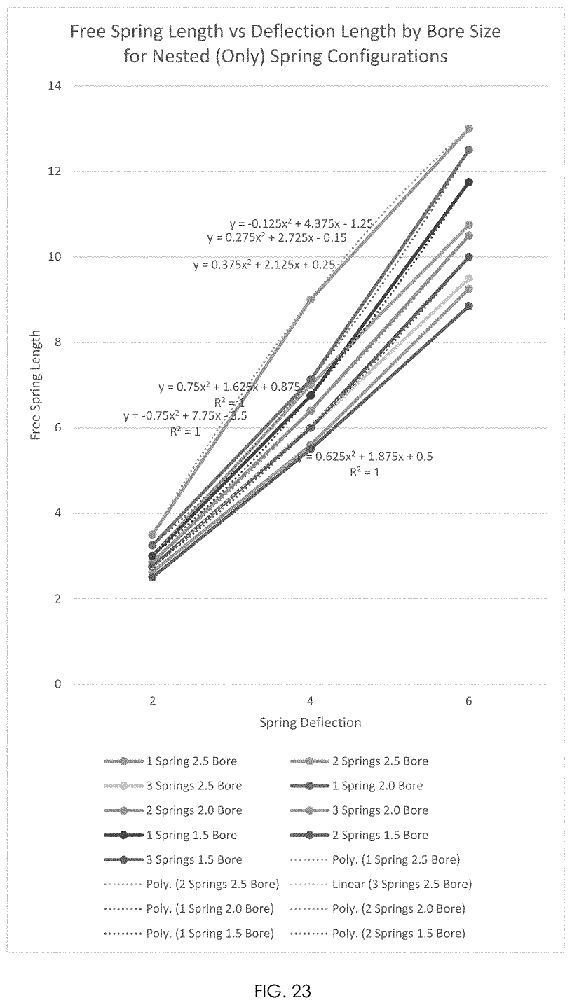

FIG. 23 shows regression curves for free spring length vs. deflection length by bore size for nested (only) spring configurations. FIG. 23 shows a relationship between the number of nested springs and free spring length for various bore sizes and strokes. Generally, the free length of a biaser configuration comprising two or more nested springs is reduced as the number of springs is increased. Bore size further influences length; generally this is related to the larger gage spring wire required to bias the larger forces associated with the larger bore size.

While the data (Tables 3 and 4) shows values for nested parallel spring configurations, similar calculations performed on non-nested parallel spring configurations will show a similar trend—a required spring length (often the same for all springs in parallel) that is less than the required length for a single spring of the same type (but different spring rate), of the same outer diameter, to achieve/allow for the same effective spring rate, and working deflection. A main difference in the calculations would be that the spring rates of the springs A and B (and C for a triple parallel, non-nested design) for a non-nested parallel design (where springs A, B and C are in parallel) would be substantially equal. Note that, as mentioned below, the term spring does not necessarily mean a single spring, as indeed, e.g., each of three springs in non-nested parallel configuration could possibly include a subset of two or more spring units, themselves parallel (nested or otherwise) and/or series configured. Note that where any single, discrete spring is intended, the term spring unit may be used; as such a single spring may include several spring units. Indeed, a more narrow version of many embodiments of the inventive technology could be described by replacing the term “spring” with “spring unit.”

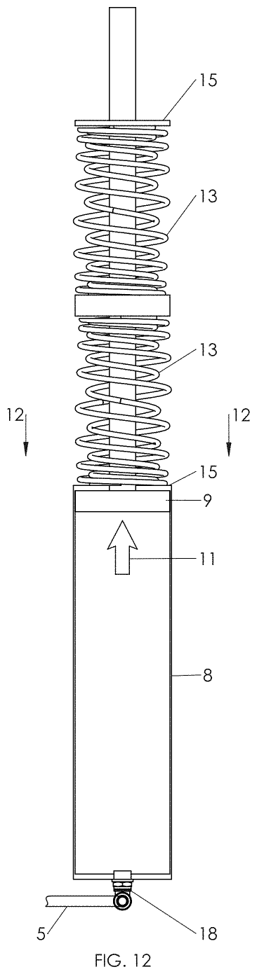

Data that is roughly analogous to the that above can be made for configurations where nested springs are established in series (see, e.g., FIGS. 11 and 12). More particularly, Table 5 shows Bimodal, Series and Nested Configuration spring data. Note that Single refers to two springs in series (no nesting); Dual refers to a configuration of four total springs, with one B Spring nested in one A Spring in series with a second B Spring nested in a second A Spring; Triple refers to a configuration where one C Spring is nested in one B Spring, which is nested in one A Spring (all three of which are in series with an identical nested sub-configuration). Note that, in Table 5, data is for each spring, such that Lw×2=Total Lw (e.g., 2×3=6, and L×2=Total L)
Free Length Reduct′n vs. Single Series Spring=(Lseries&nested(single)−Lseries&nested(dual or triple))/Lseries&nested(single), as %.
Length Increase for Series & Nested Spring vs. Nested=(2×Lseries&nested−Lnested)/Lnested, as %.
Decrease, Series & Nested Spring vs. Single Nested Spring=(Lnested(single)−2×Lseries&nested)/Lnested(single), as % (where single nested (Lnested(single)) spring is, as explained, simply one single spring, without any nesting).

TABLE 5
Nested Springs in Series (i.e., Bimodal, Series & Nested Config'n)
Bore Diameter: 2.5″
4.909 area
Combined Rate: 90 lb/in

| | | Dual | | Triple | | |
|---|---|---|---|---|---|---|
| | Single | A | B | A | B | C |
| Working Deflection (Lw) | 3 | 3 | 3 | 3 | 3 | 3 |
| Free Length (L) | 7.25 | 5.75 | 5.75 | 5 | 5 | 5 |
| Rate (lb/in) | 180 | 120 | 60 | 80 | 60 | 40 |
| Wire (d inches) | 0.334 | 0.285 | 0.205 | 0.245 | 0.2 | 0.159 |
| Mean Dia (inches) | 2.1 | 2.18 | 1.6 | 2.2 | 1.69 | 1.3 |
| Deflection (inches) | 3.01 | 3.01 | 3.23 | 3.02 | 3.06 | 3.01 |
| FreeLength/Working Deflection | 2.4 | 1.9 | 1.9 | 1.7 | 1.7 | 1.7 |
| Free Length Reduct'n vs. Single Series | | 21% | | 31% | | |
| Spring | | | | | | |
| Length Increase for Series & Nested | 12% | 7% | | 5% | | |
| Spring vs. Nested | | | | | | |
| Decrease, Series & Nested v. Single | | 12% | | 23% | | |
| Nested Spring | | | | | | |
| Working Deflection (Lw) | 2 | 2 | 2 | 2 | 2 | 2 |
| Free Length (L) | 4 | 3.5 | 3.5 | 3.25 | 3.25 | 3.25 |
| Rate (lb/in) | 180 | 120 | 60 | 80 | 60 | 40 |
| Wire (d inches) | 0.278 | 0.2435 | 0.18 | 0.215 | 0.175 | 0.14 |
| Mean Dia (inches) | 2.1 | 2.18 | 1.6 | 2.25 | 1.69 | 1.3 |
| Deflection (inches) | 2 | 2.01 | 2.04 | 2.09 | 2.08 | 2.09 |
| FreeLength/Working Deflection | 2.0 | 1.8 | 1.8 | 1.6 | 1.6 | 1.6 |
| Free Length Reduct'n vs. Single Series | | 13% | | 19% | | |
| Spring | | | | | | |
| Length Increase for Series & Nested | −11% | 0% | | 8% | | |
| Spring vs. Nested | | | | | | |
| Decrease, Series & Nested vs. Single | | 22% | | 28% | | |
| Nested Spring | | | | | | |
| Working Deflection (Lw) | 1 | 1 | 1 | 1 | 1 | 1 |
| Free Length (L) | 1.85 | 1.7 | 1.7 | 1.5 | 1.5 | 1.5 |
| Rate (lb/in) | 180 | 120 | 60 | 80 | 60 | 40 |
| Wire (d inches) | 0.22 | 0.1925 | 0.15 | 0.162 | 0.138 | 0.11 |
| Mean Dia (inches) | 2.2 | 2.25 | 1.7 | 2.25 | 1.8 | 1.3 |
| Deflection (inches) | 1.01 | 1.05 | 1.02 | 1 | 1.02 | 1.02 |
| FreeLength/Working Deflection | 1.9 | 1.7 | 1.7 | 1.5 | 1.5 | 1.5 |

| | | | |
|---|---|---|---|
| Free Length Reduct'n vs. Single Series | | 8% | 19% |
| Spring | | | |
| Length Increase for Series & Nested | 6% | 13% | 9% |
| Spring vs. Nested | | | |
| Decrease, Series & Nested vs. Single | | 3% | 14% |
| Nested Spring | | | |

| Bore Diameter: 2″ | | |
|---|---|---|
| 3.142 area | | |
| Combined Rate: 57.6 lb/in | | |
| | Dual | Triple |

| | Single | A | B | A | B | C |
|---|---|---|---|---|---|---|
| Working Deflection (Lw) | 3 | 3 | 3 | 3 | 3 | 3 |
| Free Length (L) | 7 | 5.5 | 5.5 | 4.75 | 4.75 | 4.75 |
| Rate (lb/in) | 115.2 | 80 | 35.2 | 51.2 | 40 | 24 |
| Wire (d inches) | 0.258 | 0.2237 | 0.157 | 0.192 | 0.161 | 0.1245 |
| Mean Dia (inches) | 1.6 | 1.705 | 1.25 | 1.75 | 1.385 | 1.07 |
| Deflection (inches) | 3 | 3.02 | 3.19 | 3 | 2.96 | 3.04 |
| FreeLength/Working Deflection | 2.3 | 1.8 | 1.8 | 1.6 | 1.6 | 1.6 |

| | | | |
|---|---|---|---|
| Free Length Reduct'n vs. Single Series | | 21% | 32% |
| Spring | | | |
| Length Increase for Series & Nested | 12% | 5% | 3% |
| Spring vs. Nested | | | |
| Decrease, Series & Nested vs. Single | | 12% | 24% |
| Nested Spring | | | |

| | | | | | | |
|---|---|---|---|---|---|---|
| Working Deflection (Lw) | 2 | 2 | 2 | 2 | 2 | 2 |
| Free Length (L) | 3.75 | 3.35 | 3.35 | 3 | 3 | 3 |
| Rate (lb/in) | 115.2 | 80 | 35.2 | 51.2 | 40 | 24 |
| Wire (d inches) | 0.223 | 0.195 | 0.136 | 0.166 | 0.1395 | 0.107 |
| Mean Dia (inches) | 1.75 | 1.75 | 1.25 | 1.75 | 1.385 | 1.07 |
| Deflection (inches) | 2.01 | 2.02 | 2.1 | 2 | 2.01 | 2.03 |
| FreeLength/Working Deflection | 1.9 | 1.7 | 1.7 | 1.5 | 1.5 | 1.5 |

| | | | |
|---|---|---|---|
| Free Length Reduct'n vs. Single Series | | 11% | 20% |
| Spring | | | |
| Length Increase for Series & Nested | 5% | 5% | 7% |
| Spring vs. Nested | | | |
| Decrease, Series & Nested vs. Single | | 6% | 52% |
| Nested Spring | | | |

| | | | | | | |
|---|---|---|---|---|---|---|
| Working Deflection (Lw) | 1 | 1 | 1 | 1 | 1 | 1 |
| Free Length (L) | 1.75 | 1.6 | 1.6 | 1.45 | 1.45 | 1.45 |
| Rate (lb/in) | 115.2 | 80 | 35.2 | 51.2 | 40 | 24 |
| Wire (d inches) | 0.175 | 0.155 | 0.11 | 0.13 | 0.114 | 0.09 |
| Mean Dia (inches) | 1.75 | 1.8 | 1.4 | 1.8 | 1.5 | 1.25 |
| Deflection (inches) | 1.01 | 1.01 | 1.14 | 1.01 | 1.02 | 1.09 |
| FreeLength/Working Deflection | 1.8 | 1.6 | 1.6 | 1.5 | 1.5 | 1.5 |

| | | | |
|---|---|---|---|
| Free Length Reduct'n vs. Single Series | | 9% | 17% |
| Spring | | | |
| Length Increase for Series & Nested | 8% | 12% | 10% |
| Spring vs. Nested | | | |
| Decrease, Series & Nested vs. Single | | 2% | 59% |
| Nested Spring | | | |

| Bore Diameter: 1.5″ | | |
|---|---|---|
| 1.767 area | | |
| Combined Rate: 32.4 lb/in | | |
| | Dual | Triple |

| | Single | A | B | A | B | C |
|---|---|---|---|---|---|---|
| Working Deflection (Lw) | 3 | 3 | 3 | 3 | 3 | 3 |
| Free Length (L) | 6 | 5 | 5 | 4.65 | 4.65 | 4.65 |
| Rate (lb/in) | 64.8 | 43.2 | 21.6 | 28.8 | 21.6 | 14.4 |
| Wire (d inches) | 0.1915 | 0.1635 | 0.116 | 0.142 | 0.116 | 0.0909 |
| Mean Dia (inches) | 1.3 | 1.32 | 0.95 | 1.3 | 1 | 0.75 |
| Deflection (inches) | 3.01 | 2.99 | 3.13 | 3.06 | 3.03 | 3 |
| FreeLength/Working Deflection | 2.0 | 1.7 | 1.7 | 1.6 | 1.6 | 1.6 |

| | | | |
|---|---|---|---|
| Free Length Reduct'n vs. Single Series | | 17% | 23% |
| Spring | | | |
| Length Increase for Series & Nested | 2% | 0% | 5% |
| Spring vs. Nested | | | |
| Decrease, Series & Nested vs. Single | | 15% | 21% |
| Nested Spring | | | |

| | | | | | | |
|---|---|---|---|---|---|---|
| Working Deflection (Lw) | 2 | 2 | 2 | 2 | 2 | 2 |
| Free Length (L) | 3.5 | 3.125 | 3.125 | 2.85 | 2.85 | 2.85 |
| Rate (lb/in) | 64.8 | 43.2 | 21.6 | 28.8 | 21.6 | 14.4 |
| Wire (d inches) | 0.1635 | 0.142 | 0.101 | 0.123 | 0.102 | 0.81 |
| Mean Dia (inches) | 1.3 | 1.32 | 0.95 | 1.35 | 1.05 | 0.8 |
| Deflection (inches) | 2 | 2.005 | 2.105 | 2.04 | 2.01 | 2.01 |
| FreeLength/Working Deflection | 1.8 | 1.6 | 1.6 | 1.4 | 1.4 | 1.4 |

| | | | |
|---|---|---|---|
| Free Length Reduct'n vs. Single Series | | 11% | 19% |
| Spring | | | |
| Length Increase for Series & Nested | 4% | 4% | 4% |
| Spring vs. Nested | | | |
| Decrease, Series & Nested vs. Single | | 7% | 16% |
| Nested Spring | | | |

| | | | | | | |
|---|---|---|---|---|---|---|
| Working Deflection (Lw) | 1 | 1 | 1 | 1 | 1 | 1 |
| Free Length (L) | 1.6 | 1.5 | 1.5 | 1.35 | 1.35 | 1.35 |
| Rate (lb/in) | 64.8 | 43.2 | 21.6 | 28.8 | 21.6 | 14.4 |
| Wire (d inches) | 0.129 | 0.1106 | 0.082 | 0.095 | 0.0817 | 0.063 |
| Mean Dia (inches) | 1.35 | 1.32 | 0.95 | 1.35 | 1.15 | 0.8 |
| Deflection (inches) | 1.02 | 1.04 | 1.05 | 1 | 1.03 | 1.03 |
| FreeLength/Working Deflection | 1.6 | 1.5 | 1.5 | 1.4 | 1.4 | 1.4 |

| | | | |
|---|---|---|---|
| Free Length Reduct'n vs. Single Series | | 6% | 16% |
| Spring | | | |
| Length Increase for Series & Nested | 7% | 9% | 8% |
| Spring vs. Nested | | | |
| Decrease, Series & Nested vs. Single | | 0% | 10% |
| Nested Spring | | | |

It is also of note, with respect to data of Table 5, that all percentage values indicated therein are examples of values that may be found within ranges that are descriptive of various possible embodiments of the inventive technology. For example, Free Length/Working Deflection could be less than or equal to any one of 2.2, 2.0, 1.75, 1.5, and 1.25 (but typically greater than 1.0). Free Length Reduction vs. Single Series Spring could be greater than any one of 5%, 10%, 15% and 18%. Length Increase for Series & Nested Spring vs. Nested could be less than any one of 2%, 3%, 5%, 8%, and 10%. The Decrease Series & Nested vs. Single Nested Spring could be greater than any one of 0%, 2%, 3%, 5%, 6%, 8%, 9%, 10%, 13%, 15%, 20%, 30% and 50%. Particular embodiments may thus be described as having configurations that effect any of the above indication limitations.

Table 6 shows a summary of Table 5 data, presented in alternate format. Note that free lengths for associated deflection lengths of 1″, 2″ and 3″ (where bore size, number of springs, and rate stays the same), would be twice the free spring lengths shown in Table 6).

TABLE 6
Free Spring Lengths For Deflection Lengths of 2″, 4″ and 6″

| | Free Spring Length (ins.) | | |
|---|---|---|---|
| Deflection Length | 2 | 4 | 6 |
| 2.5 Bore, 90 lb Rate | | | |
| 1 Spring 2.5 Bore | 3.7 | 8 | 14.5 |
| 2 Springs 2.5 Bore | 3.4 | 7 | 11.5 |
| 3 Springs 2.5 Bore | 3 | 6.5 | 10 |

2.0 Bore, 57.6 Rate

| | | | |
|---|---|---|---|
| 1 Spring 2.0 Bore | 3.5 | 7.5 | 14 |
| 2 Springs 2.0 Bore | 3.2 | 6.7 | 11 |
| 3 Springs 2.0 Bore | 2.9 | 6 | 9.5 |

1.5 Bore, 32.4 Rate

| | | | |
|---|---|---|---|
| 1 Spring 1.5 Bore | 3.2 | 7 | 12 |
| 2 Springs 1.5 Bore | 3 | 6.25 | 10 |
| 3 Springs 1.5 Bore | 2.7 | 5.7 | 9.3 |

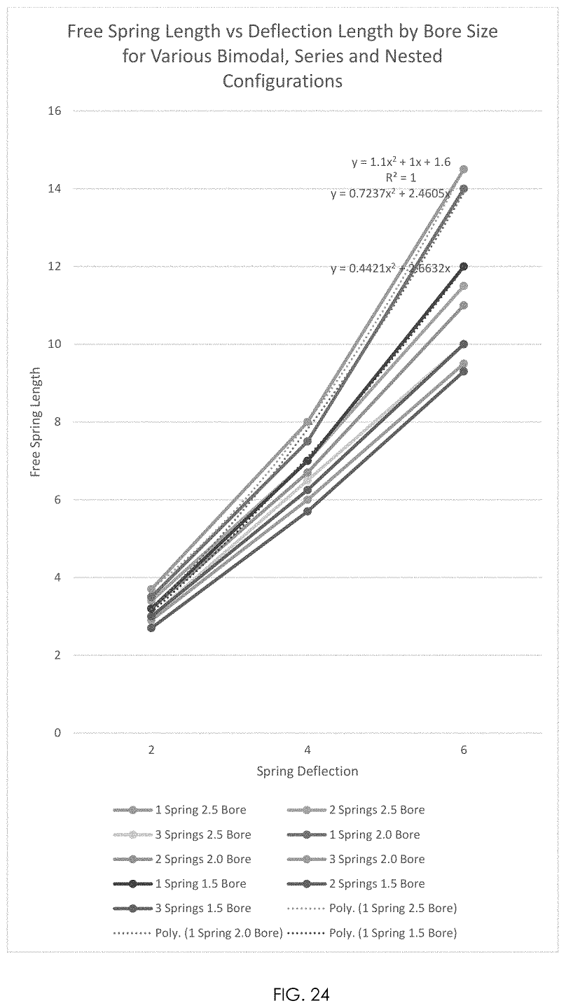

FIG. 24 shows regression curves for free spring length vs. deflection length by bore size for various bimodal series and nested configurations. FIG. 24 shows a relationship between the number of nested springs that are also stacked in series, and free spring length for various bore sizes and strokes. The free length of a biaser comprising springs in series is generally longer than non-series springs, but there are benefits for longer stroke applications where a single spring may buckle reducing the linearity of the spring rate. Series springs, equipped with an “Anti-Buckling” guide between the springs are prevented from buckling which provides a more consistent spring rate throughout the stroke. The trade off in free length of series springs vs. single springs is generally minimal, <10% in most cases. Additionally, two nested springs in series may be the same length as a single spring while affording far greater linearity throughout the stroke.

By utilizing the regression line derived from FIG. 23 and/or FIG. 24 plots one may quickly model the approximate biaser design to minimize biaser free length for a specific stroke length and given bore size. Note that while the bores sizes listed are typical pneumatic bore sizes, in some cases biasers may be external to a cylinder and not restricted by bore size. One significant advantage to external biaser is that in general the free length is reduced proportionately to diameter for a given spring rate. By having the spring external, one is not restricted by the internal bore diameter of the actuating cylinder.

Table 7 shows a comparison of data of Table 6 with data of Table 4. Table 7 shows that typically, use of a nested only (i.e., not nested and series) configuration achieves some degree of length space savings (e.g., more than any one of 0″, 0.2″, 0.4″, 0.6″, 0.8″, 1.0″, and 1.3″) as compared with series and nested configuration only. Such difference in free length may also be expressed as a percentage (i.e., the difference in free length/free length of series and nested). Embodiments of the inventive technology involving springs in nested only configuration may achieve free length reductions as compared with series and nested only configurations (e.g., for at least 90% of applications) that are any one of: more than 1%, more than 3%, more than 5%, more than 7%, more than 10% and more than 12%. Differences in Free Length/Working Deflection (such ratios as shown in Tables 3 and 5), expressed as a percentage (i.e., such difference divided by the associated Free Length/Working Deflection for series and nested configurations (see Table 5) may also exhibit a similar trends (for more than 90% of applications), and indeed may be said to be within similar ranges (i.e. any one of: more than 1%, more than 3%, more than 5%, more than 7%, more than 10% and more than 12%). While a “hard and fast” rule that nested only configurations allow for the use of springs with free lengths that are lest than those of series and nested configurations, it may be said that generally (e.g., for more than 90% of the applications, each defined by a bore size, spring rate and deflection length, at least one of which is different for each application), nested only configurations (where no springs are in series), offer space savings as compared with space requirements of series and nested configurations for the same application.

TABLE 7
Difference Between Free Lengths for Series
& Nested As Compared With Nested Only

| | Free Length Difference | | |
|---|---|---|---|
| | (Series&Nested-NestedOnly) | | |
| Deflection Length | 2 | 4 | 6 |
| 2.5 Bore, 90 lb Rate | | | |
| 1 Spring 2.5 Bore | 0.2 | −1 | 1.5 |
| 2 Springs 2.5 Bore | 0.4 | 0 | 0.75 |
| 3 Springs 2.5 Bore | 0.25 | 0.5 | 0.5 |
| 2.0 Bore, 57.6 Rate | | | |
| 1 Spring 2.0 Bore | 0.25 | 0.375 | 1.5 |
| 2 Springs 2.0 Bore | 0.35 | 0.3 | 0.5 |
| 3 Springs 2.0 Bore | 0.275 | 0.4 | 0.25 |
| 1.5 Bore, 32.4 Rate | | | |
| 1 Spring 1.5 Bore | 0.2 | 0.25 | 0.25 |
| 2 Springs 1.5 Bore | 0.25 | 0.25 | 0 |
| 3 Springs 1.5 Bore | 0.2 | 0.2 | 0.45 |

Table 7 shows that, for the larger bore (4″), there can be a length savings with series and nested compared to nested only. Table 7 may show that there is no “hard rule” on whether or not series plus (and) nested is better than nested only. Whether or not one configuration or the other is better may depend on bore and stroke.

It is of note that certain embodiments of the inventive technology may exhibit one or more features shown in U.S. Pat. No. 8,132,665 and/or U.S. Pat. No. 9,133,865 (either referred to as Anysize®), and/or U.S. Pat. No. 9,677,576, each of said patents hereby incorporated herein in its entirety.

Benefits afforded by certain embodiments of the inventive technology (among other advantages) may include:
1. Improvement in rate linearity over displacement distance by preventing buckling
2. Improvement in rate consistency across a plurality of biasers (bias elements) designed for the same rate (with multiple springs the overall rate is an average of all the springs that comprise the biaser, thus discrepancies in rate between individual springs have less effect the more springs there are.
3. Reduction of F/D ratio such that the biaser fits in a smaller space.
4. Both nested and parallel springs reduce the F/D ratio of the biaser compared to a single spring.
   a. Two nested springs have an F/D ratio 10%-15% less than single springs
   b. Three nested springs have a F/D ratio 20%-30% less than single springs
   c. For larger displacements single springs will often buckle making them non-linear over the displacement. Nesting or parallel springs reduce the F/d ratio enough in many cases so the spring will not buckle.
5. Springs in series have a combined F/D ratio approximately 5%-10% greater than the equivalent non series springs, however the advantage is that a guide (e.g., the afore-described disc) can be added between the series springs to prevent either from buckling. This disc may be preferred to a simple spring guide such as a UHMW cylinder or rod which simply limits buckling because there can still be friction between the spring and guide which affects rate linearity. For series springs neither spring buckles—the guide is merely a disk, perhaps with a hole though its center (such that it is a collar) between the two springs which ensures they are kept concentric to one another throughout the displacement.
   a. An assembly comprising two single springs in series will have a F/D ratio approximately 5-10% greater than a single spring biaser.
   b. An assembly comprising two dual nested springs in series will have a F/D ratio approximately 5-10% greater than a dual nested spring biaser but 10%-20% shorter than a single spring biaser.
   c. An assembly comprising three dual nested springs in series will have a F/D ratio approximately 5%-10% greater than a three nested spring biaser but 10%-60% shorter than a single spring biaser.

As mentioned, certain apparatus may include one or more physically biased, pressurized positioner assembly(ies) where one or more springs (more generally, biasers) are external of the pressure cylinder(s), regardless of whether such pressure cylinder(s) itself each has internal spring(s) or not. Springs external of the pressure cylinder(s) of a physically biased, pressurized positioner assembly may or may not themselves be in a cylinder. External bias elements may be mechanically connected with (a broad term that even includes magnetic connection) a positioner via bar(s), support(s), etc., so as to provide a force that opposes the pressure force (e.g., a pneumatic pressure force). There may be provided a support(s) (stationary) that secures an end of one or more of the external springs (such may be achieved by stationarily securing a cylinder in those designs where external springs are within cylinder(s)). Note that as used in this disclosure, bias elements are considered external where they are external of the pressure cylinder(s) of the physically biased, pressurized positioner assembly (so bias elements within a cylinder (a non-pressure cylinder) may be considered external). The pressure may be adjusted to achieve the desired positioner location. External spring(s) may be on one side, or even both sides, of a pressure cylinder(s).

A physically biased, pressurized positioner assembly that incorporates external biasers may be another way to create a desired bias force and/or provide a desired stroke range, to fit into a desired location. It may also (like other external bias element designs) allow for the use of existing, conventional pressurized cylinders (which may or may not have a spring therein) to generate novel physically biased, pressurized positioner assemblies to meet the demands/needs of a particular application (particularly with respect to space constraints, bias force needs, etc.) A conventional, single spring pressure cylinder may have inherent limits with respect to bore diameter, stroke, and/or force (piston area×pressure) of the cylinder. By using biasers that are external from the pressure cylinder, there may be fewer limits on spring size, stroke, etc. For example, a conventional, single spring in pressure cylinder can be replaced with a no internal spring pressure cylinder with one or more external springs. If, e.g., a larger diameter single external spring can be used, then generally it can be shorter in length for the same stroke (because that spring no longer needs to be fit inside the cylinder).

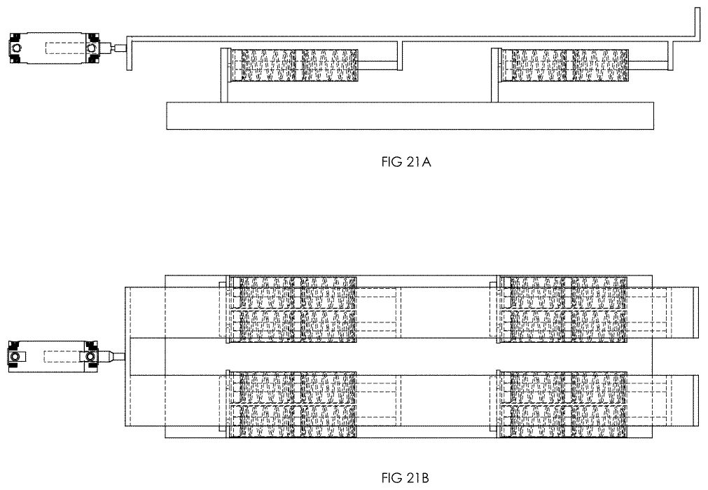

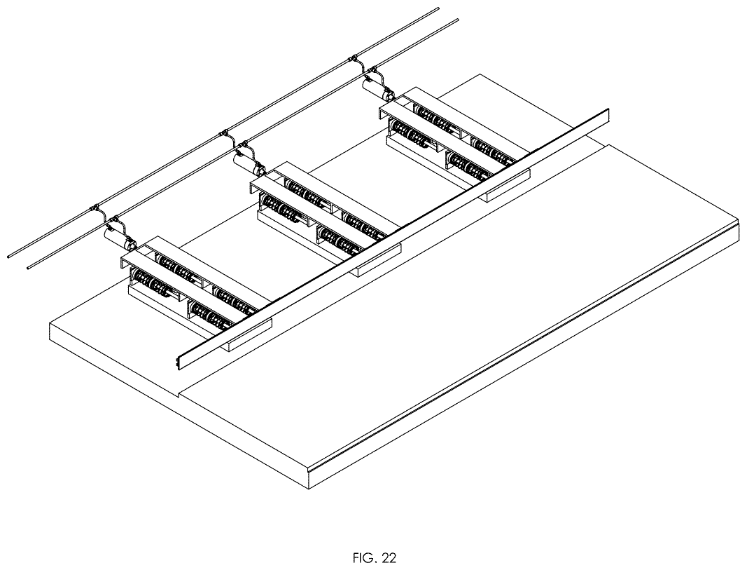

Particular applications of the “external biaser” inventive technology include but are not limited to: positioner assemblies; overhead guide rail adjustment; multilane infeed to a case packer; guide rail positioning (with one or more lanes are attached to a guide rail); those applications where it is desired to combine a conventional cylinder with external spring configurations to effectively generate a sufficiently precise positioning; applications to meet an imposed stroke, positioning resolution, bias force, spatial, cost, retrofitting, or other constraint/desire. Of course, more than one physically biased, pressurized positioner assembly may be used in each zone, each assembly of that zone supplied air from the same regulated (control) pressure source, e.g., where a plurality of assemblies are repeated down the length of a conveyor. Pressure may be regulated specifically with respect to a zone, an individual pressure cylinder, an individual positioner assembly, and/or a group of assemblies, to provide the desired positioning of that zone, cylinder, group, etc. As with many of the embodiments disclosed herein, bias element configurations may be selected in order to meet a bias force constraint/desire (e.g., if a 5500 biaser is unavailable, then 5200 and 5300 biasers may be configured in series and parallel to effectively generate a 5500 bias force) for a physically biased, pressurized positioner assembly. Particular embodiments of this aspect of the inventive technology may be seen in, e.g., FIGS. 21 and 22. Note that such figures may be most notably different from some other external biaser configurations in that the biasers move along an axis that is not co-linear with (but is parallel with) the movement axis of the piston within the pressure cylinder.

As with other embodiments (e.g., strictly internal bias element embodiments where all biasers are established within the pressure cylinder), bias elements may be selected so that they match based on certain characteristics (e.g., spring rate, max stroke range, etc.), but this is not a requirement at all, as different biasers may be grouped together in series and or parallel (nested parallel and non-nested parallel) configurations, either uni-, bi-, or trimodally, to provide the desired configuration/response. Also, as with other embodiments, in a single assembly, there may be one or more pressure cylinders, and there may be none, one, or more cylinders in which external biasers are situated. As with any of the various multiple biaser, positioner assembly embodiments disclosed herein, more springs may improve the overall rate distribution of the entire assembly.

FIGS. 21 and 22 show, in exemplary manner, an pneumatic overhead guide rail adjustment system. Each overhead adjustment assembly includes a common bar that two or more guide rail support brackets are attached to. This bar may be suspended via bearings from an overhead support. There may be several biasers connected between the bar and the support; the cylinder pushes against the bar which pushes against the biasers. Each overhead assembly may be connected to the same control air (in the same zone); dozens may be connected to the same airline (and thus within the same zone).

More particularly as to certain exemplary systems of this generalized embodiment, such systems may feature:
Modular biasing system where the biasers are external to the cylinder (pressure or not (e.g., vented)); when combined, such may be referred to a positioner assembly;
Where two or more positioner assemblies are daisy chained together, a single displacement (pressure) may control a plurality of positioners. An exemplary, multilane infeed might have 12 or more of these spaced 3-4′ apart down the length of the infeed;
External biasers may be matched (e.g., for each positioner assembly) based on characteristics (spring rate, max stoke range) and may be grouped together in parallel or series to create a biaser with characteristics that may not be achievable or practical with a single biaser. In other embodiments, biasers within each positioner may instead be a mix of different biaser characteristics as long as the plurality of positioner assemblies all share the same biaser characteristics;
Assemblies may feature more than one cylinder within a single positioner assemble, although this is not a requirement; and
Biasers may be precision springs, or non-precision springs.

Advantages/goals of particular “external biaser” embodiments of the inventive technology disclosed herein is that the convention design approach—installing a single biaser within the body tube of each cylinder to make a positioner—limits one to the bore diameter and stroke, and force (piston area×pressure) of the cylinder. By utilizing biasers separate from the cylinder, one is virtually unlimited in what their application. So, for example, if one can use a larger diameter spring then generally it can be shorter in length for the same stroke, since there is no longer a need to fit that spring inside a cylinder (so the cylinder can be much larger in diameter).

One example of an external biaser configuration (4 biasers total) may be as follows: 2 biasers, in parallel, with a 100 lb spring rate and a 2″ stroke and 2 more biasers, in parallel, with a 200 lb spring rate and a 1″ stroke. Both pairs of biasers are configured in series for a combined biasing characteristic of 150 lb spring rate with 3″ of stroke. As long as each positioner assembly is made up of the same biasers and as long as the combined biaser characteristics match between positioner assembly, then each positioner assembly will move the same down the length of the line, under the same regulated pressure.

It is also of note that there may be applications where it is not desired to necessarily controllably reposition an item using a pressurized, regulated fluid (e.g., pneumatically), and instead, merely support an item (and leave it at a certain position and/or allow it to move within a range where the supported weight changes). Such aspect of the inventive technology might not include a pressure cylinder, or a regulated pressure source (although it will include biasers and perhaps one or more cylinders in which biaser(s) are established). The external biaser configurations disclosed herein (i.e., the disclosure remaining in this application, with the pressurized lines, regulated pressure source, etc., excluded) may be a biased support invention in their own right. Claims as filed in this application, but without pressurized fluid related features/elements, are considered as describing aspects of this technology. An example application includes but is not limited to biaser configurations mounted overhead to support a heavy top cover (where bias elements provide a supporting force). Generally, this aspect of the inventive technology may be described as a biaser assembly.

In certain embodiments, including when used along with a cylinder or an Anysize® positioner, where the biaser is not supplied air (e.g. it is not established in a non-vented pressure cylinder), the cylinder might simply vent (including being open on both ends) so there was not a volume of air contained. The caveat may be that the positioners may be those with an internal spring (Anysize®), or they may comprise a cylinder (with a single air input but no internal spring) pushing on a biaser or several biasers which are external but mechanically connected to that cylinder that is receiving the input pressure.

As can be easily understood from the foregoing, the basic concepts of the present invention may be embodied in a variety of ways. It involves both motion control techniques as well as devices to accomplish the appropriate control. In this application, the motion control techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of a substance or condition in a particular input, output, or at a particular stage can be specified as substantially only x or substantially free of x, as a value of about x, or such other similar language. Using percentage values as one example, these types of terms should be understood as encompassing the options of percentage values that include 99.5%, 99%, 97%, 95%, 92% or even 90% of the specified value or relative condition; correspondingly for values at the other end of the spectrum (e.g., substantially free of x, these should be understood as encompassing the options of percentage values that include not more than 0.5%, 1%, 3%, 5%, 8% or even 10% of the specified value or relative condition, all whether by volume or by weight as either may be specified. In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “biaser” should be understood to encompass disclosure of the act of “biasing”—whether explicitly discussed or not—and, conversely, were there effectively disclosure of the act of “biasing”, such a disclosure should be understood to encompass disclosure of a “biaser” and even a “means for biasing” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the positioner devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1-71. (canceled)

72. A pressurized, physically biased system comprising:
a plurality of physically biased, pressurized positioner assemblies of a single positioning zone; and
a pressurized fluid source and pressure transfer system configured to supply pressurized fluid to said physically biased, pressurized positioner assemblies,
wherein each of said physically biased, pressurized positioner assemblies comprises:
a pressure cylinder able to contain an internal, fluidic pressure;
a piston within said pressure cylinder;
said piston configured to move by application of pressure in a first relative direction;
a plurality of n number of springs that are each configured to exert an effective bias force that is opposite said first relative direction,
wherein some of said n number of springs are series configured, and wherein said system further comprises at least one anti-buckling disc, established between two different of said series configured springs; and
a positioner that moves in response to said piston.

73. The pressurized, physically biased system as described in claim 72 wherein said plurality of springs have a maximum outer diameter, are capable of a working deflection amount, and are all substantially of the same length, and wherein said length is less than a length required for a single spring having a similar outer diameter to achieve a similar working deflection amount.

74. The pressurized, physically biased system as described in claim 73 wherein said length is at least 10% less than a length required for a single spring having a similar outer diameter to achieve a similar working deflection amount.

75. The pressurized, physically biased system as described in claim 73 wherein said length is at least 15% less than a length required for a single spring having a similar outer diameter to achieve a similar working deflection amount.

76. The pressurized, physically biased system as described in claim 73 wherein said length is at least 20% less than a length required for a single spring having a similar outer diameter to achieve a similar working deflection amount.

77. The pressurized, physically biased system as described in claim 73 wherein said length is at least 25% less than a length required for a single spring having a similar outer diameter to achieve a similar working deflection amount.

78. The pressurized, physically biased system as described in claim 73 wherein said length is at least 30% less than a length required for a single spring having a similar outer diameter to achieve a similar working deflection amount.

79. The pressurized, physically biased system as described in claim 73 wherein said length is at least 40% less than a length required for a single spring having a similar outer diameter to achieve a similar working deflection amount.

80. The pressurized, physically biased system as described in claim 72 wherein at least some of said n number of springs are nested configured.

81. A pressurized, physically biased system comprising:
a plurality of physically biased, pressurized positioner assemblies of a single positioning zone;
a pressurized fluid source and pressure transfer system configured to supply pressurized fluid to said physically biased, pressurized positioner assemblies,
wherein each of said physically biased, pressurized positioner assemblies comprises:
a pressure cylinder able to contain an internal, fluidic pressure;
a piston within said pressure cylinder;
a pressure force acting on said piston in a first relative direction;
a plurality of bias elements configured to exert an effective bias force that is opposite said first relative direction, wherein some of said plurality of bias elements are series configured, and
wherein said system further comprises at least one anti-buckling disc, established between two different of said series configured springs;
a positioner that moves with said piston.

82. The pressurized, physically biased system as described in claim 81 wherein at least some of said plurality of bias elements are nested configured.

83. A pressurized, physically biased system comprising:
a plurality of physically biased, pressurized positioner assemblies of a single positioning zone; and
a pressurized fluid source and pressure transfer system configured to supply pressurized fluid to said physically biased, pressurized positioner assemblies,
wherein each of said physically biased, pressurized positioner assemblies comprises:
a pressure cylinder able to contain an internal, fluidic pressure;
a piston within said pressure cylinder;
said piston configured to move by application of pressure in a first relative direction;
a plurality of n number of springs that are each configured to exert an effective bias force that is opposite said first relative direction, wherein each of said n-number of springs comprises a subset of serially configured springs; and
a positioner that moves in response to said piston.

84. The pressurized, physically biased system as described in claim 82 wherein at least some of said n number of springs are nested configured.

85. A pressurized, physically biased system comprising:
a plurality of physically biased, pressurized positioner assemblies of a single positioning zone;
a pressurized fluid source and pressure transfer system configured to supply pressurized fluid to said physically biased, pressurized positioner assemblies,
wherein each of said physically biased, pressurized positioner assemblies comprises:
a pressure cylinder able to contain an internal, fluidic pressure;
a piston within said pressure cylinder;
a pressure force acting on said piston in a first relative direction;
a plurality of bias elements configured to exert an effective bias force that is opposite said first relative direction, wherein at least some of said bias elements comprise a subset of serially configured springs; and
a positioner that moves with said piston.

86. The pressurized, physically biased system as described in claim 84 wherein at least some of said bias elements of springs are nested configured.
